(19) United States
(12) Patent Application Publication
(10) Pub. No.: US 2003/0024361 A1
(43) Pub. Date: Feb. 6, 2003

(54) Punch

(75) Inventor: Hideyuki Kikuchi, Kawasaki-shi (JP)

Correspondence Address: Johnny A. Kumar, FOLEY & LARDNER, Washington Harbour, 3000 K Street, N.W.,Suite 500, Washington, DC, 20007-5109, US

(73) Assignee: TOSHIBA TEC KABUSHIKI KAISHA

(21) Appl. No.: 09/921,696

(22) Filed: Aug. 6, 2001

(51) Int. Cl. B26F 1/24; B26D 5/00

(52) U.S. Cl. 83/30; 83/368; 83/660

(57) ABSTRACT

A punching apparatus includes a setting input section setting the number and positions of holes to be punched out in a paper sheet, a transfer mechanism to send the paper sheet to a process stage, and a plurality of line sensors to detect posture of the paper sheet sent to the process stage. The punching apparatus also includes a holding portion holding a plurality of pins to punch a hole in the paper sheet, a slide mechanism to slide the holding portion along the rail, and a rotating mechanism to rotate the holding portion, a pin interval adjusting mechanism to adjust intervals between the pins, a pin projecting and retracting mechanism to independently project and retract the pins relative to the holding portion, and an elevator mechanism to move down the holding portion toward the paper sheet to cause the pins to act on the paper sheet. The posture of the paper sheet sent to the process stage is detected by the line sensors. The pin is moved in accordance with the posture, so that holes of the set number are punched at the set position.

### BACKGROUND OF THE INVENTION

The present invention relates to a punching apparatus that punches a hole in a sheet-like medium, and particularly to a punching apparatus serving as a finisher of a copying machine.

In recent years, a type of copying machine that copies an original image on paper has been widely used, which includes a finisher such as a stapler for stapling a plurality of paper sheets on which an image is copied, or a punch (a punching apparatus) for making a hole in a predetermined position of each paper sheet.

A punching apparatus transfers a paper sheet to be processed, and stops it at a predetermined process position, makes a punching pin standing by the process position act on the paper sheet, and punches a hole in a predetermined position of the paper sheet. In the conventional punching apparatus, the number of holes to be punched in a paper sheet, or the number of pins, intervals between holes, or intervals between pins, and the positions of the holes are fixedly determined. For example, the apparatus causes two pins arranged at a fixed interval to act near one side of a paper sheet and punches two holes along the side.

However, when a paper sheet is transferred to and stopped at the process position, the paper sheet may be sent to the process position in an inclined state or in a deviated position. In this case, if one tries to punch holes in the predetermined position of the paper sheet, holes may be punched at an incorrect position.

### BRIEF SUMMARY OF THE INVENTION

The present invention was made in consideration of the above matters. Its object is to provide a punching apparatus and a punching method, which can detect posture of a sheet-like medium and punch a desired number of holes in desired positions based on the detection result.

To achieve the above object, a punching apparatus of the present invention comprises: a setting section to set a number and a position of holes to be punched in a sheet-like medium; a transfer mechanism to A transfer the sheet-like medium in a predetermine direction and send it to a predetermined process position; a detecting section to detect posture of the sheet-like medium sent to the process position; and a punching mechanism, including at least one pin to punch a hole in the sheet-like medium sent to the process position, to move the at least one pin based on a result of detection by the detecting section and punch holes of the number set by the setting section at the position set by the setting section.

A punching method of the present invention comprises: setting a number and a position of holes to be punched in a sheet-like medium; transferring the sheet-like medium in a predetermine direction and sending it to a predetermined process position; detecting posture of the sheet-like medium sent to the process position; and moving a punching pin in accordance with the posture of the sheet-like medium and punching holes of the number set in the setting at the position set in the setting.

### BRIEF DESCRIPTION OF THE SEVERAL VIEWS OF THE DRAWING

FIG. 1 is a perspective view showing a schematic structure of a punching apparatus according to a first embodiment of the present invention;

FIG. 2 is an enlarged front view showing a structure of a main part of the punching apparatus shown in FIG. 1;

FIG. 3 is a plan view showing a line sensor which detects posture of a paper sheet sent to a process stage of the punching apparatus shown in FIG. 1;

FIG. 4 is a block diagram showing a control system which controls an operation of the punching apparatus shown in FIG. 1;

FIG. 5 is a flowchart to explain operations of the punching apparatus shown in FIG. 1;

FIG. 6 is an operation explanatory diagram to explain an example of operations of the punching apparatus shown in FIG. 1;

FIG. 7 is a front view showing a structure of a main part of a punching apparatus according to a second embodiment of the present invention;

FIG. 8 is a block diagram showing a control system which controls an operation of the punching apparatus shown in FIG. 7; and

FIGS. 9 and 10 are operation explanatory diagrams to explain examples of operations of the punching apparatus shown in FIG. 7.

### DETAILED DESCRIPTION OF THE INVENTION

Embodiments of the present invention will be described in detail with reference to the drawings.

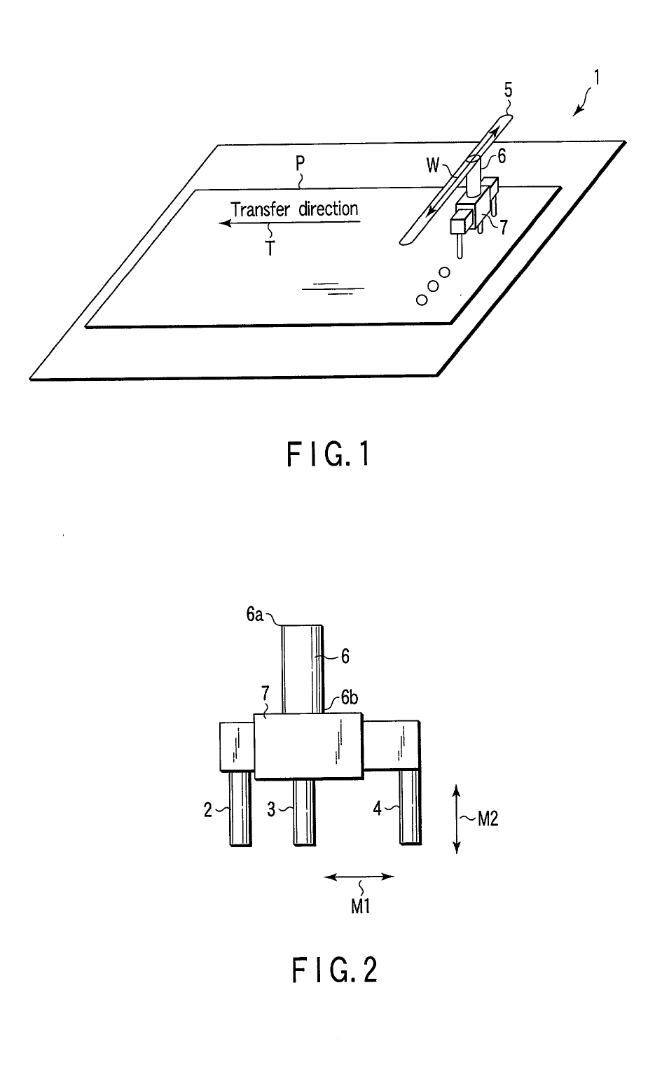

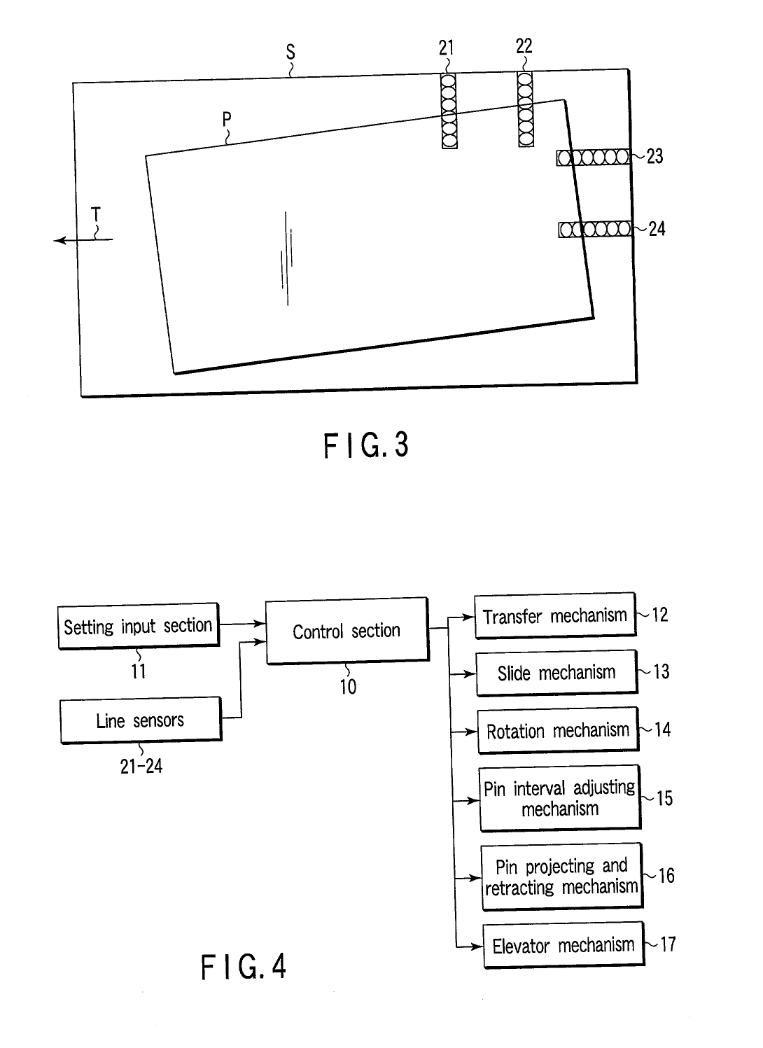

FIG. 1 shows in a perspective view a schematic structure of a punching apparatus 1 according to a first embodiment of the present invention. FIG. 2 shows a structure of a main part of the punching apparatus 1 in an enlarged view. FIG. 3 shows positions of arrangement of four line sensors to detect posture of a paper sheet P sent to a process stage. FIG. 4 shows a block diagram of a control system which controls an operation of the punching apparatus 1.

The punching apparatus 1 includes a transfer mechanism 12 (transfer means) which transfers a paper sheet P to be processed (a sheet-like medium) in the direction of an arrow T (FIG. 1) and sends it to a predetermined process stage S (process position). The transfer mechanism 12 sends the paper sheet P to the process stage S and stops it temporarily, or causes the paper sheet P to pass through the process stage S at a fixed speed.

Four line sensors 21, 22, 23 and 24 (detecting means) for detecting posture (inclination and positional deviation) of the paper sheet P sent to the process stage S are disposed on the process stage S. Each of the line sensors 21, 22, 23 and 24 has a plurality of pairs of optical sensors, constituting a light emitting section and a light receiving section that face each other from above and below with the process stage S interposed therebetween. The pairs of optical sensors are arranged such that the passage positions of the optical axes thereof are aligned in a straight line. FIG. 3 shows the passage positions of the optical axes of the respective optical sensors.

As shown in FIG. 3, two line sensors 21 and 22 are located at positions to detect one side of the paper sheet P along the transfer direction, i.e., on the rear side of the apparatus. The two line sensors 21 and 22 extend in a direction perpendicular to the transfer direction T from an end portion of the rear side of the process stage S.

The remaining two line sensors 23 and 24 are located at position to detect the rear end of the paper sheet P in the transfer direction, i.e., on the right side of the drawing. The two line sensors 23 and 24 extend in the transfer direction from an end portion of the entrance side of the process stage S.

Thus, the four line sensors 21, 22, 23 and 24 detect end sides of the paper sheet by interruption of the plurality of optical axes by the paper sheet P, so that inclination (skew) or positional deviation (shift) of the paper sheet P is detected by the known method.

A rail 5 extends in a predetermined opposing position above the process stage S. It allows three punching pins 2, 3 and 4 to slide along a width direction W perpendicular to the transfer direction T. Needless to say, the rail 5 extends in the width direction W above the process stage S with a predetermined distance apart therefrom.

A proximal end portion 6a of a rotary shaft 6 extending in a vertical direction is slidably and rotatably attached to the rail 5. A holding portion 7 which movably holds the three pins 2, 3 and 4 is provided on a distal end portion 6b of the rotary shaft 6. The holding portion 7 is attached to the rotary shaft 6 so as to be movable up and down.

As shown in FIG. 4, a control section 10 for controlling operations of the punching apparatus 1 described above is connected to a setting input section 11 (setting means) for setting the number of holes to be punched out in the paper sheet P and the positions of the holes. It is also connected to the four line sensors 21, 22, 23 and 24 described above.

The control section 10 is further connected to the above-described transfer mechanism 12 for transferring the paper sheet P in the direction of the arrow T and sending it to the process stage S, a slide mechanism 13 for sliding the rotary shaft 6 of the holding portion 7 along the rail 5 in the directions of an arrow W, and a rotating mechanism 14 to rotate the rotary shaft 6 of the holding portion 7 relative to the rail 5.

Furthermore, the control section 10 is connected to a pin interval adjusting mechanism 15 (adjusting mechanism) for adjusting intervals between the pins 2, 3 and 4 by independently moving the three pins 2, 3 and 4 whose proximal end portions are held by the holding portion 7 in the directions of an arrow M1. It is also connected to a pin projecting and retracting mechanism 16 (projecting and retracting mechanism) to independently project and retract the three pins 2, 3 and 4 in the directions of an arrow M2 relative to the holding portion 7.

Moreover, the control section 10 is connected to an elevator mechanism 17 for sliding the holding portion 7 up and down along the rotary shaft 6, so that the tips of the pins 2, 3 and 4 can act on the paper sheet P arranged on the process stage S to punch holes.

The three pins 2, 3, 4, the slide mechanism 14, the rotating mechanism 14, the pin interval adjusting mechanism 15, the pin projecting and retracting mechanism 16 and the elevator mechanism 17 function as punching means of the present invention which can arbitrarily set the number and positions of holes. Thus, with the punching means of the present invention, a desired number of holes can be punched out in desired positions of the paper sheet P.

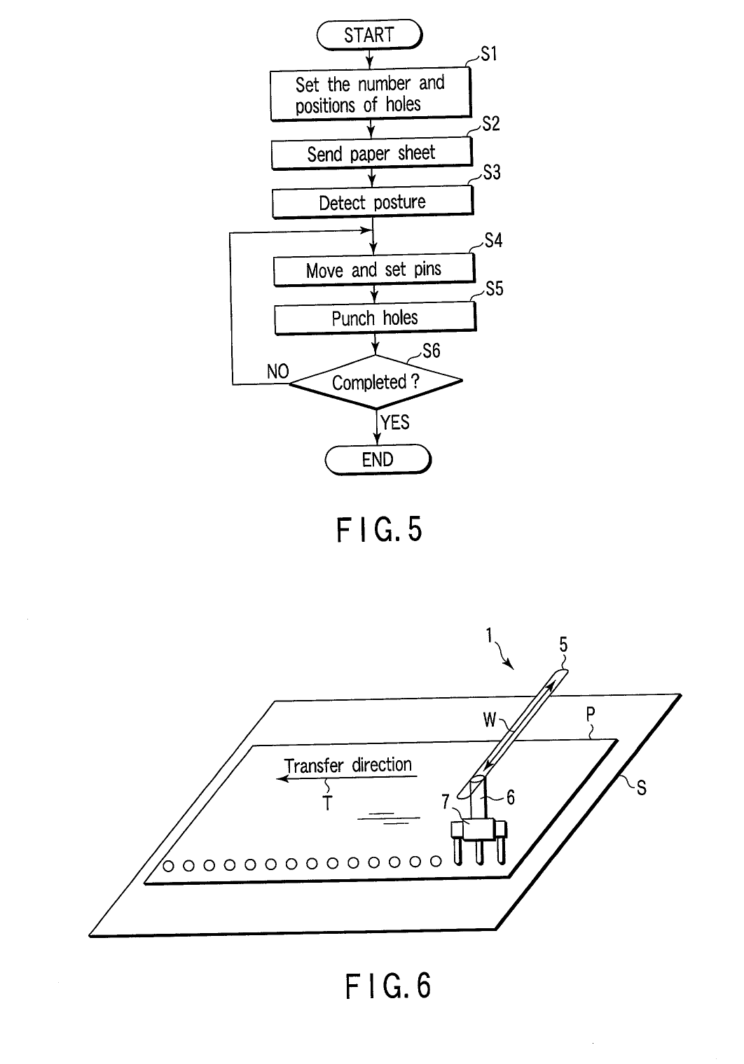

Operations by the punching apparatus 1 constructed as described above will now be described with reference to the flowchart of FIG. 5.

Prior to the operations, the number and positions of holes to be punched in the paper sheet P are set by the operator (step 1). Then, the paper sheet P to be processed is sent to the process stage S by the transfer mechanism 12 (step 2).

Further, the posture of the paper sheet P is detected by means of the four line sensors 21, 22, 23 and 24 (step 3). At this time, inclination and positional deviation in the width direction (the directions of the arrow W) relative to the process stage S are detected.

Subsequently, the slide mechanism 13, the rotating mechanism 14, the pin interval adjusting mechanism 15 and the pin projecting and retracting mechanism 16 are operated based on the number and positions of holes set in the step 1 and the posture of the paper sheet P detected in the step 3. As a result, the three pins 2, 3 and 4 are set in appropriate conditions (step 4). Then, the elevator mechanism 17 is operated to punch holes of the number set in the step 1 at the positions set in the step 1 (step 5).

Since the punching apparatus 1 of this embodiment comprises three pins 2, 3 and 4, the number of holes that can be punched out by one operation is at most three. Therefore, if four or more holes are to be punched out (step 6: No), the process returns to the step 4 and the conditions of the pins 2, 3 and 4 are reset.

More specifically, in the step 4, the pin projecting and retracting mechanism 16 is operated in accordance with the number of holes to be punched in the paper sheet P. For example, if two holes are to be punched by one operation, the pin projecting and retracting mechanism 16 is operated to house one of the three pins 2, 3 and 4 in the holding portion 7. As a result, the pin housed in the holding portion 7 does not act on the paper sheet P and two holes are punched out. Further, in the step 4, the pin interval adjusting mechanism 15 is operated in accordance with the interval of holes to be punched in the paper sheet P.

Particularly, in the step 4, if the paper sheet P sent to the process stage S is skewed, the rotating mechanism 14 is operated to rotate the holding portion 7 in accordance with the skew. If the paper sheet P is shifted in the width direction, the slide mechanism 13 is operated to slide the holding portion 7 along the rail 5.

As described above, according to this embodiment, even if the paper sheet P is skewed or shifted, holes of the desired number can be accurately punched out at desired positions.

Example of specific operations of the punching apparatus 1 of the first embodiment will be described below.

First, an example of a first operation of punching six holes at regular intervals along a rear end side of a paper sheet P sent to the process stage S will be described with reference to, mainly, FIG. 1.

In the example of the first operation, the three pins 2, 3 and 4 are adjusted at regular intervals by the pin interval adjusting mechanism 15. The three pins 2, 3 and 4 are projected from the holding portion 7 by means of the pin projecting and retracting mechanism 15. The holding portion 7 is rotated by the rotating mechanism 14 to the posture as shown in FIG. 1, so that the three pins 2, 3 and 4 are arranged in the width direction W. The holding portion 7 is lowered toward the paper sheet P by the elevator mechanism 17. As a result, three holes arranged in the width direction are punched in the paper sheet P.

At this time, if the paper sheet P is skewed, the rotating mechanism 14 is operated to rotate the holding portion 7 in accordance with the skew, before the holding portion 7 is lowered by the elevator mechanism 17. If the paper sheet P is shifted, the slide mechanism 13 is operated to slide the holding portion 7 along the rail 5 in accordance with the shift, before the holding portion 7 is lowered by the elevator mechanism 17.

After the three holes are punched in the paper sheet P, the elevator mechanism 17 is operated to lift up the pins 2, 3 and 4 to punch three other holes. Then, the holding portion 7 is slid to the rear side of the apparatus by the slide mechanism 13. Further, the holding portion 7 is lowered by the elevator mechanism 17, with the result that the three pins 2, 3 and 4 are caused to act on the paper sheet P, thereby punching three other holes.

Next, an example of a second operation of operating the punching apparatus 1 to punch a plurality of holes along a front side of the paper sheet P in the transfer direction will be described with reference to FIG. 6.

In the example of the second operation, the holding portion 7 is slid by the slide mechanism 13 to a predetermined position of the front side. The three pins 2, 3 and 4 are adjusted at regular intervals by means of the pin interval adjusting mechanism 15. The three pins 2, 3 and 4 are projected from the holding portion 7 by the pin projecting and retracting mechanism 16. The holding portion 7 is rotated by the rotating mechanism 14 to the posture as shown in FIG. 6, so that the three pins 2, 3 and 4 are arranged in the transfer direction T. The holding portion 7 is lowered toward the paper sheet P by the elevator mechanism 17. As a result, three holes arranged in the transfer direction are punched in the paper sheet P.

At this time, if the paper sheet P is skewed, the rotating mechanism 14 is operated to rotate the holding portion 7 in accordance with the skew, before the holding portion 7 is lowered by the elevator mechanism 17. If the paper sheet P is shifted, the slide mechanism 13 is operated to slide the holding portion 7 along the rail 5 in accordance with the shift, before the holding portion 7 is lowered by the elevator mechanism 17.

After the three holes are punched in the paper sheet P, the elevator mechanism 17 is operated to lift up the pins 2, 3 and 4. The paper sheet P is transferred by the transfer mechanism 12 for a predetermined distance. Then, the holding portion 7 is lowered by the elevator mechanism 17, causes the three pins 2, 3 and 4 to act on the paper sheet P, and punches three holes. This series of operations are repeated a predetermined number of times, so that a desired number of holes are punched along the front side of the paper sheet P.

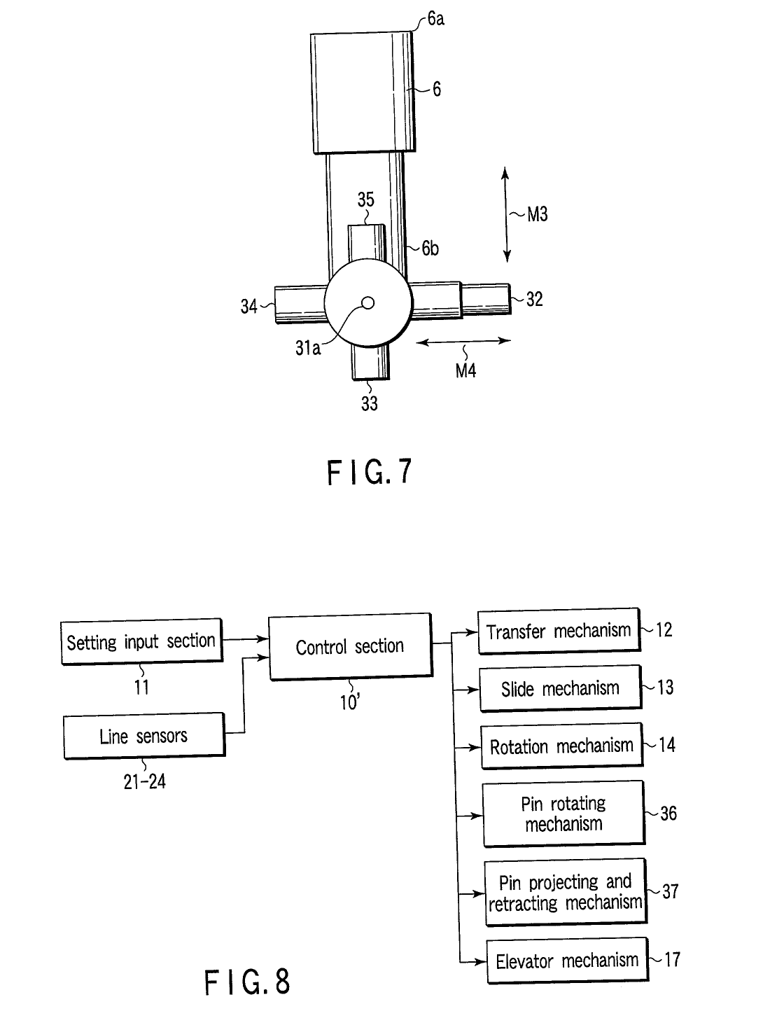

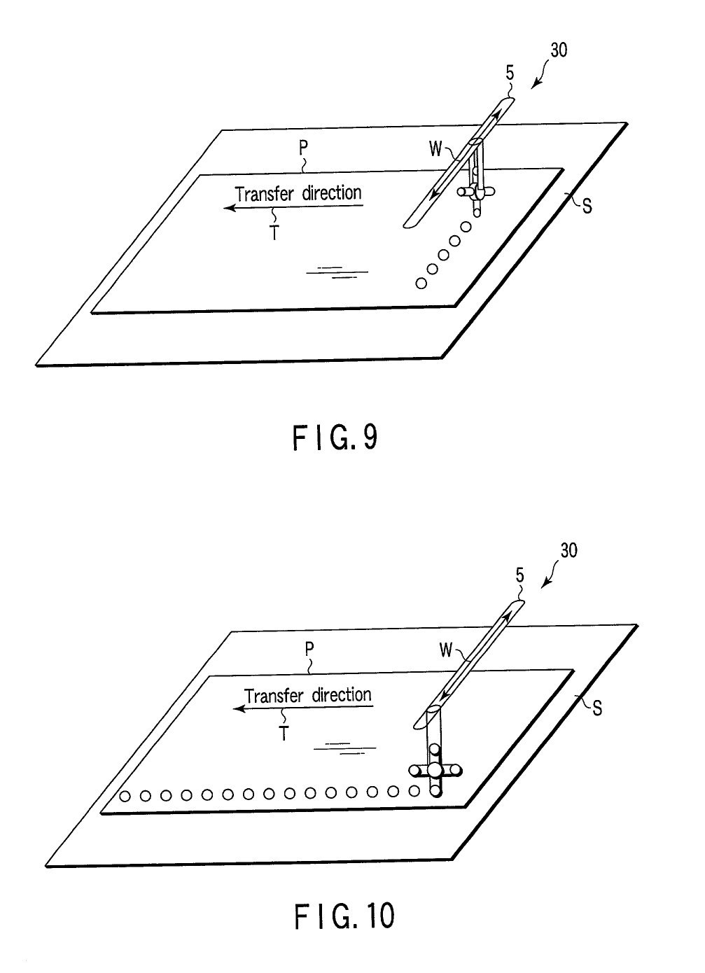

A punching apparatus 30 according to a second embodiment of the present invention will now be described with reference to FIGS. 7 to 10. FIG. 7 shows a schematic structure of a main part of the punching apparatus of this embodiment. FIG. 8 is a block diagram showing a control system which controls an operation of the punching apparatus of this embodiment. FIGS. 9 and 10 are perspective views of the punching apparatus 30. The structural elements that function in the same manner as in the first embodiment are identified by the same reference numerals as those of the first embodiment, and detailed descriptions thereof are omitted. In the following, only the portions different from those of the first embodiment will be described in detail.

As shown in FIG. 7, the punching apparatus 30 of this embodiment includes a holding portion 31 formed of a substantially cylindrical rotary body. The holding portion 31 is rotatably attached to the end portion 6a of the rotary shaft 6 slidably and rotatably attached to the rail 5. The holding portion 31 is slidable relative to the rotary shaft 6 in vertical directions (in the directions of an arrow M3). A rotary shaft 31a of the holding portion 31 extends in a direction perpendicular to the rotary shaft 6 attached to the rail 5.

Four pins 32, 33, 34 and 35 are projected radially from the circumference of the holding portion 31. The four pins 32, 33, 34 and 35 are attached so as to be projectable and retractable relative to the holding portion 31 in the directions of an arrow M4.

As shown in FIG. 8, a control section 10′ for controlling operations of the punching apparatus of this embodiment is connected to a setting input section 11, line sensors 21, 22, 23 and 24, a transfer mechanism 12, a slide mechanism 13, a rotating mechanism 14 and an elevator mechanism 17, as in the case of the first embodiment.

The control section 10′ is also connected to a pin rotating mechanism 36 (rotating mechanism) to rotate the holding portion 31 about the rotary shaft 31a and a pin projecting and retracting mechanism 37 to independently project and retract the four pins 21, 22, 23 and 24 relative to the holding portion 31.

Example of specific operations of the punching apparatus 30 of the second embodiment will now be described.

First, an example of a first operation of punching a plurality of holes along a rear end side of a paper sheet P sent to the process stage S will be described with reference to, mainly, FIG. 9.

In the example of the first operation, first, the pin projecting and retracting mechanism 37 is operated on the basis of the operation conditions input through the setting input section 11, and a predetermined number of pins 32-35 are projected from the holding portion 31. Then, the rotating mechanism 14 is operated to rotate the holding portion 31 to the posture shown in FIG. 9, so that the direction of rotation of the pins coincides with the width direction (the arrow W direction). As a result, the rotary shaft 6 is moved by the slide mechanism 13 to the front side of the apparatus.

From this state, the holding portion 31 is lowered toward the paper sheet P by the elevator mechanism 17. While the rotary shaft 6 is slid by the slide mechanism 13 along the rail 5 toward the rear side of the apparatus, the holding portion 31 is rotated by the pin rotating mechanism 36. At this time, the holding portion 31 is rotated in the same direction as the slide direction of the holding portion 31, so that a plurality of holes aligned along the width direction are punched in the paper sheet P.

If the paper sheet P sent to the process stage S by the transfer mechanism 12 is skewed, the rotating mechanism 14 is operated to rotate the holding portion 31 in accordance with the skew, before the holding portion 31 is lowered by the elevator mechanism 17. If the paper sheet P is shifted, the slide mechanism 13 is operated to slide the holding portion 31 along the rail 5 in accordance with the shift, before the holding portion 31 is lowered by the elevator mechanism 17.

Next, an example of a second operation of operating the punching apparatus 30 to punch a plurality of holes along a front side of the paper sheet P in the transfer direction will be described with reference to FIG. 10.

In the example of the second operation, first, the pin projecting and retracting mechanism 37 is operated on the basis of the operation conditions input through the setting input section 11, and a predetermined number of pins 32-35 are projected from the holding portion 31. Then, the rotating mechanism 14 is operated to rotate the holding portion 31 to the posture shown in FIG. 10, so that the direction of rotation of the pins coincides with the transfer direction (the arrow T direction). As a result, the rotary shaft 6 is moved by the slide mechanism 13 to the front side of the apparatus.

From this state, the holding portion 31 is lowered toward the paper sheet P by the elevator mechanism 17. While the paper sheet P is transferred by the transfer mechanism 12 in the direction of the arrow T through the process stage S, the holding portion 31 is rotated by the pin rotating mechanism 36. At this time, the holding portion 31 is rotated in the same direction as the transfer direction of the paper sheet P, so that a plurality of holes aligned along the transfer direction of the paper sheet P are punched in the paper sheet P.

If the paper sheet P is skewed, the rotating mechanism 14 is operated to rotate the holding portion 31 in accordance with the skew, before the holding portion 31 is lowered by the elevator mechanism 17. If the paper sheet P is shifted, the slide mechanism 13 is operated to slide the holding portion 31 along the rail 5 in accordance with the shift, before the holding portion 31 is lowered by the elevator mechanism 17.

As described above, the punching apparatus according to the second embodiment is adapted to continuously punch a plurality of holes. It can perform a punching operation faster than the apparatus of the first embodiment.

The present invention is not limited to the above embodiments, but can be modified variously within the scope of the present invention.

What is claimed is:

1. A punching apparatus comprising:
setting means for setting a number and a position of holes to be punched in a sheet-like medium;
transfer means for transferring the sheet-like medium in a predetermine direction and sending it to a predetermined process position;
detecting means for detecting posture of the sheet-like medium sent to the process position; and
punching means, including at least one pin to punch a hole in the sheet-like medium sent to the process position, for moving the at least one pin based on a result of detection by the detecting means and punching holes of the number set by the setting means at the position set by the setting means.

2. A punching apparatus according to claim 1, wherein the detecting means detects inclination and positional deviation of the sheet-like medium sent by the transfer means to the process position.

3. A punching apparatus according to claim 2, wherein the punching means including a plurality of pins to punch holes in the sheet-like medium sent to the process position and a holding portion holding the plurality of pins, the holding portion being slid in accordance with the positional deviation of the sheet-like medium detected by the detecting means and rotated in accordance with the inclination of the sheet-like medium detected by the detecting means.

4. A punching apparatus according to claim 3, wherein the punching means includes an adjusting mechanism to adjust intervals between the plurality of pins.

5. A punching apparatus according to claim 3, wherein the punching means includes a projecting and retracting mechanism to project and retract the plurality of pins relative to the holding portion.

6. A punching apparatus according to claim 3, wherein the holding portion is a rotary body from which the plurality of pins are projected radially.

7. A punching apparatus according to claim 6, wherein the punching means includes a rotating mechanism to rotate the rotary body.

8. A punching apparatus according to claim 6, wherein the punching means includes a projecting and retracting mechanism to project and retract the plurality of pins relative to the rotary body.

9. A punching method comprising:
setting a number and a position of holes to be punched in a sheet-like medium;
transferring the sheet-like medium in a predetermined direction and sending it to a predetermined process position;
detecting posture of the sheet-like medium sent to the process position; and
moving a punching pin in accordance with the posture of the sheet-like medium and punching holes of the number set in the setting at the position set in the setting.

10. A punching method according to claim 9, wherein in the detecting, inclination and positional deviation of the sheet-like medium sent to the process position are detected.

11. A punching method according to claim 10, wherein in the punching, a holding portion holding the pin is slid in accordance with the positional deviation of the sheet-like medium detected in the detecting and rotated in accordance with the inclination of the sheet-like medium detected in the detecting.

12. A punching method according to claim 10, wherein in the punching, the sheet-like medium is transferred through the process position and the holding portion, which is a rotary body and from which the pin is radially projected, is rotated in the predetermined direction.
